(19) United States
(12) Patent Application Publication
(10) Pub. No.: US 2018/0303069 A1
(43) Pub. Date: Oct. 25, 2018

(54) AUTO-RETRACTING SECURABLE LEASH WITH PET ID TAG

(71) Applicant: Steven M. Cox, Livermore, CA (US)

(72) Inventor: Steven M. Cox, Livermore, CA (US)

(21) Appl. No.: 15/959,098

(22) Filed: Apr. 20, 2018

Related U.S. Application Data
(60) Provisional application No. 62/488,723, filed on Apr. 22, 2017.

(51) Int. Cl. A01K 27/00

(52) U.S. Cl. CPC A01K 27/004; A01K 11/00; A01K 27/001

(57) ABSTRACT

Disclosed are stylized leash cases containing an automatic retracting system with an attached leash and collar coupler, with the capability to secure the collar coupler into a columnar housing, thus allowing a pet owner to leave the leash case attached to a pet collar, thereby providing both an emergency leash and a safe leash with no or minimal danger to the pet from external hazards. Various stylized leash case designs are possible, including an elliptical style (e.g., oval), a dog bone style, and other stylized leash case designs.

### CROSS-REFERENCE TO RELATED APPLICATION

This application claims the benefit of priority of U.S. Provisional Patent Application 62/488723, filed Apr. 22, 2017 and titled “Combination Leash and ID Tag,” the disclosure of which is incorporated by reference. This application is related to Design Patent Application No. 29/598872, filed Mar. 29, 2017 and titled “Combination Leash and ID Tag”, and which is incorporated by reference. This application is related to Design Patent Application No. 29/598877, filed Mar. 29, 2017 and titled “Carabiner,” and which is incorporated by reference. This application is related to Design patent application Ser. No. 29/601,480, filed Apr. 22, 2017 and titled “Combination Leash and ID Tag,” and which is incorporated by reference.

### STATEMENT REGARDING FEDERALLY SPONSORED RESEARCH OR DEVELOPMENT

Not Applicable

### BACKGROUND OF THE INVENTION

### Field of Invention

The invention relates generally to the field of pet leashes and identification (ID) tags and more specifically to retractable pet leashes with integrated identification tags.

### Description of Related Art

The marketplace is well-supplied with pet leashes and pet identification tags. These products generally have a single purpose, to wit, function as a leash for exercising or transporting a pet, or a separate identification tag attached to a collar. But what to do when a pet goes off-leash?

### SUMMARY OF THE INVENTION

Disclosed is an auto-retracting securable leash with pet id tag which includes an automatic retractable leash and is capable of restraining the leash case to a pet while the pet is off-leash.

Disclosed are stylized leash cases containing an automatic retracting system with an attached leash and collar coupler, with the capability to secure the collar coupler into a columnar housing thus allowing a pet owner to leave the leash case attached to a pet collar, thereby providing both an leash and a safe leash with no or minimal danger to the pet from external hazards. Various stylized leash case designs are possible, including an elliptical style (e.g., oval), a dog bone style, and other stylized leash case designs.

An auto-retracting securable leash with pet id tag (100) comprises a leash spool (105) capable of bi-directional rotation wherein the leash spool (105) comprises an leash retracting mechanism (107) capable of auto-rotation in one direction wherein the leash spool (105) is rotatably affixed within a stylized design case (110) wherein the stylized design case (110) comprises a front case cover (115), a left case cover (120), a right case cover (125), a top case cover (130), a back case cover (135) and a bottom case cover (140), wherein the top case cover (130) comprises a columnar housing (145), wherein the columnar housing (145) comprises a leash coupler base port (150) capable of receiving within a leash coupler base (205), and a leash coupler stem slot (155) above the leash coupler base port (150) and capable of receiving within a leash coupler stem (210), and wherein the columnar housing (145) further comprises at least one interior detent (160) capable of securing the leash coupler stem (210) within the columnar housing (145), and the columnar housing (145) is capable of restraining a leash and collar connector (200) to the columnar housing (145) to restrain the stylized design case (110) to a pet collar.

The stylized design case (110) may have an oval shape comprising a front case cover (115) having a flat elliptical shape, a back case cover (135) having a flat elliptical shape, wherein a horizontal bisecting line (310) bisecting the front case cover (115) comprises a proximal terminus (315) and a distal terminus (320) at opposite terminus edges of the front case cover (115), with a vertical bisecting line (325) bisecting the front case cover (115) wherein the vertical bisecting line (325) perpendicularly bisects the horizontal bisecting line (310) such that the vertical bisecting line (325) is centrally located between the proximal terminus (315) and the distal terminus (320), wherein the columnar housing (145) is centrally aligned on the vertical bisecting line (325) and is co-linear to the vertical bisecting line (325), and the front case cover (115) is a mirror image of the back case cover (135).

The stylized design case (110) may have a dog bone shape, comprising a front case cover (445) having a flat elliptical center, wherein a horizontal bisecting line (410) bisecting the front case cover (445) comprises a proximal terminus (415) and a distal terminus (420) at opposite terminus edges of the front case cover (445), wherein the proximal terminus (415) comprises a first terminus point for a diametric line to the top case cover for a first half-circle projection (425) extending outward at plus 60 degrees to the horizontal bisecting line (410), the proximal terminus (415) comprises a first terminus point for a diametric line to the bottom case cover for a second half-circle projection (430) extending outward at minus 60 degrees to the horizontal bisecting line (410), the distal terminus (420) comprises a first terminus point for a diametric line to the top case cover for a third half-circle projection (435) extending outward at minus 120 degrees to the horizontal bisecting line (410), the distal terminus (420) comprises a first terminus point for a diametric line to the bottom case cover for a fourth half-circle projection (440) extending outward at minus 120 degrees to the horizontal bisecting line (410), such that the front case cover (445) comprises a stylized bone design, wherein a vertical bisecting line (450) bisecting the front case cover (445) wherein the vertical bisecting line (450) perpendicularly bisects the horizontal bisecting line (410) such that the vertical bisecting line (450) is centrally located between the proximal terminus (415) and the distal terminus (420), wherein the columnar housing (145) is centrally aligned on the vertical bisecting line (450) and is co-linear to the vertical bisecting line (450), and the back case cover (135) is a mirror image of the front case cover (445).

### BRIEF DESCRIPTION OF THE DRAWINGS

FIG. 1 shows an interior view of an exemplary auto-retracting securable leash with pet id tag in a bone configuration.

FIG. 2 shows a left side view of an auto-retracting securable leash with pet id tag in a bone configuration.

FIG. 3 shows a top view of an auto-retracting securable leash with pet id tag in an elliptical case i.e., oval configuration.

FIG. 4 shows a bottom view of an auto-retracting securable leash with pet id tag in an elliptical (oval) configuration.

FIG. 5 shows a back view of an auto-retracting securable leash with pet id tag in an elliptical (oval) configuration.

FIG. 6 shows a front view of an auto-retracting securable leash with pet id tag in an elliptical (oval) configuration.

FIG. 7 shows a front view of an auto-retracting securable leash with pet id tag in an elliptical (oval) configuration with alignment lines.

FIG. 8 shows a back view of an auto-retracting securable leash with pet id tag in a bone configuration with alignment lines.

FIG. 9A shows a front view of flat-top embodiment of a leash and collar connector of an auto-retracting securable leash with pet id tag.

FIG. 9B shows a front view of flat-top embodiment of a leash and collar connector of an auto-retracting securable leash with pet id tag.

FIG. 10 shows a bottom view of a leash coupler portion for a leash and collar connector (200) of an auto-retracting securable leash with pet id tag.

FIG. 11 shows a side view of round-top example for a leash and collar connector (200) of an auto-retracting securable leash with pet id tag.

FIG. 12 shows a left side view of a carabiner leash and collar connector (200) of an auto-retracting securable leash with pet id tag.

FIG. 13 shows a right side view of a carabiner leash and collar connector (200) of an auto-retracting securable leash with pet id tag.

FIG. 14 shows a stylized design case (110) of an auto-retracting securable leash with pet id tag in a person's hand, with the stylized design case (110) tethered by the leash (109) to the leash and collar connector (200), which is attached to a pet collar of a pet.

### DETAILED DESCRIPTION OF THE INVENTION

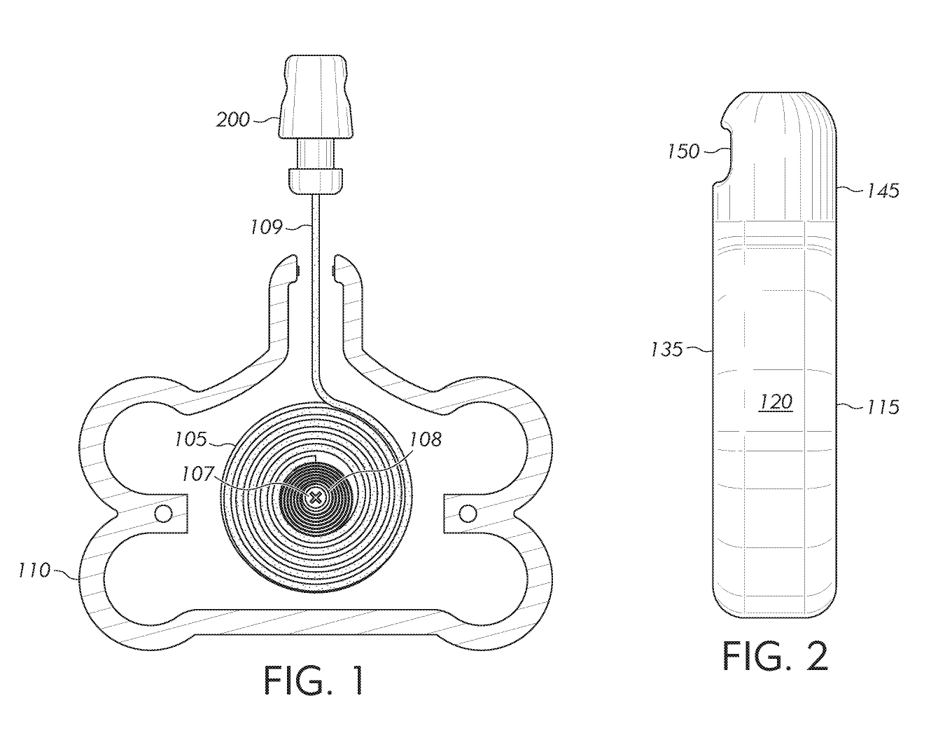

FIG. 1 shows an exemplary auto-retracting securable leash with pet id tag.

Shown in FIG. 1 are a leash spool (105), leash retracting mechanism (107), spool spindle (108), leash (109), stylized design case (110) and a leash and collar connector (200).

The leash spool (105), the leash retracting mechanism (107), and the spool spindle (108) provide retracting tension onto the leash (109) and retract the leash (109) when the leash (109) lacks external tension to extract the leash or keep the leash (109) extracted. The leash spool (105), the leash retracting mechanism (107), and the spool spindle (108) may be made of any material or materials suitable for use with a pet leash retractor for the prescribed tension. The leash spool (105) and the spool spindle (108) might be made of plastic, metal or other suitable material while the leash retracting mechanism (107) might be metal. In some embodiments, the material may be steel, other metal, plastic or other suitable material. The leash retracting mechanism (107) may be a coil spring.

Characteristics of use suggest that a user's maximum extracting tension would not exceed 160 pounds. For that reason, in some embodiments, the leash (109) has a tensile strength of about 160 pounds. In some embodiments, the leash (109) may be a braided material. In some embodiments, the leash (109) may be Kevlar. In some embodiments, the leash (109) may be steel. Other materials are possible. Similarly, the material or materials for the leash spool (105), the leash retracting mechanism (107), and the spool spindle (108) must be sufficiently robust to withstand these forces. Other use characteristics provide for tensile strength of about 120 pounds.

The stylized design case (110) may be made of any material suitable for use with a pet leash case. In some embodiments, the stylized design case (110) may be made of plastic, metal or other material. As disclosed here, multiple shapes for the stylized design case are possible. In some embodiments, the stylized design case (110) may have a dog bone shape. In some embodiments, the stylized design case (110) may have an oval shape. In some embodiments, the stylized design case (110) may have an animal shape, such as a dog or other animal. In some embodiments, the shape of the stylized design case (110) may facilitate holding of the auto-retracting securable leash with pet id tag in a person's hand.

FIG. 2 shows a left side view of an auto-retracting securable leash with pet id tag in a bone configuration.

Show in FIG. 2 are side views of the stylized design case (110), the front case cover (115), the left case cover (120), the back case cover (135), the columnar housing (145) and the leash coupler base port (150).

In some embodiments, the stylized design case (110) may be made of two halves to allow for insertion and assembly of the leash spool (105), the leash retracting mechanism (107), the spool spindle (108) and the leash (109).

In some embodiments, the front case cover (115) may be one-half and the back case cover (135) as the other half, with each half having its respective half of the columnar housing (145) and half of each of the top, left, right side and bottom case covers.

As shown in FIG. 2, the front case cover (115) and the back case cover (135) may be flat faced to provide for affixing a pet identification tag or label to the front case cover (115) or the back case cover (135), or both.

In some embodiments, the left case cover (120) has a smooth finish (i.e., texture) for a comfortable fit in a person's palm.

The columnar housing (145) holds a leash coupler base (205) portion of a leash and collar connector (200) to the auto-retracting securable leash with pet id tag. In some embodiments, the columnar housing (145) is integrated into the stylized design case (110). In some embodiments, the columnar housing (145) is sized to fit between two fingers of a person's hand.

Within the columnar housing (145) is a leash coupler base port (150) for capturing and holding a leash coupler base (205) portion of a leash and collar connector (200). In this configuration, the leash coupler base port (150) secures the leash (109) to the case so that the stylized design case (110) is likely to stay close to the pet's collar so the case less likely to be entrapped by an object and contribute to an injury to the pet.

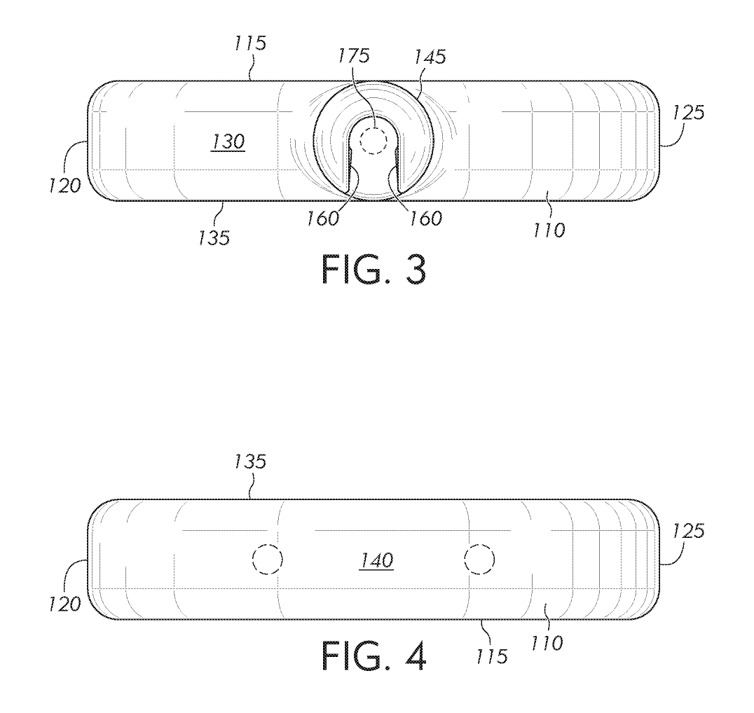

FIG. 3 shows a top view of an auto-retracting securable leash with pet id tag in an oval configuration.

Shown in FIG. 3 are the stylized design case (110), here in an elliptical (oval) configuration, the front case cover (115), the left case cover (120), the right case cover (125), the back case cover (135), the top case cover (130), the columnar housing (145), at least one interior detent (160) of the columnar housing (145) and a leash hole (175).

As shown in FIG. 3, in some embodiments, the left case cover (120) and the right case cover (125) are a mirror image when viewed from the top so that the auto-retracting securable leash with pet id tag may be quickly grasped regardless of left or right orientation.

Similarly, in some embodiments, the sides of the top case cover (130) on either side of the columnar housing (145) are smooth and mirror images to each other so that the auto-retracting securable leash with pet id tag may be quickly grasped regardless of left or right orientation.

FIG. 4 shows a bottom view of an auto-retracting securable leash with pet id tag in an oval configuration.

Shown in FIG. 4 are the stylized design case (110), here in an elliptical (oval) configuration, the front case cover (115), the left case cover (120), the right case cover (125), the back case cover (135), and the bottom case cover (140).

As shown in FIG. 4, in some embodiments, the left case cover (120) and the right case cover (125) are smooth and a mirror image to each other when viewed from the bottom so that the auto-retracting securable leash with pet id tag may be quickly grasped regardless of left or right orientation.

In some embodiments, the bottom case cover (140) is smooth and with mirror imaged left and right sides so that the auto-retracting securable leash with pet id tag may be quickly grasped regardless of left or right orientation.

Some embodiments of the bottom case cover (140) may have vent or drill holes.

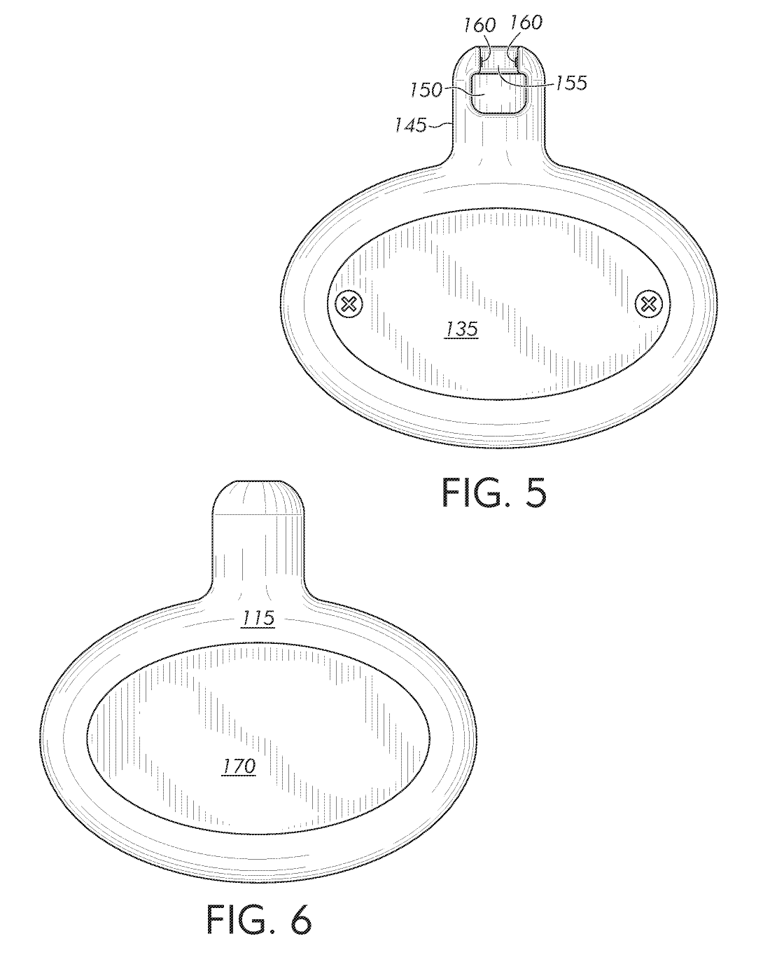

FIG. 5 shows a back view of an auto-retracting securable leash with pet id tag in an elliptical (oval) configuration.

Shown in FIG. 5 are the stylized design case (110), here in an elliptical (oval) configuration, the back case cover (135), the columnar housing (145), the leash coupler base port (150), a leash coupler stem slot (155), and at least one interior detent (160).

The leash coupler base port (150) is sized to receive a leash coupler base (205) of a leash and collar connector (200), thus providing a restraint to hold the leash and collar connector (200) in the columnar housing (145). In some embodiments, the leash coupler base port (150) the sized to accept a leash coupler base (205) having a diameter of one-quarter inch (¼″).

The leash coupler stem slot (155) is sized to receive a leash coupler stem (210) of a leash and collar connector (200), thus providing a restraint to hold the leash and collar connector (200) in the columnar housing (145). In some embodiments, the leash coupler stem slot (155) the sized to accept a leash coupler stem (210) having a diameter of three-sixteenths inch ( 3/16″).

Thus, in these embodiments, the leash coupler stem slot (155) has a smaller diameter than the leash coupler base port (150). In some embodiments, the overall combined height of the leash coupler base (205) plus the leash coupler stem slot (155) is three-eighths inch (⅜″).

The at least one interior detent (160) provides static friction against a leash coupler stem (210) portion of a leash and collar connector (200) in the columnar housing (145), thereby restraining the leash and collar connector (200) to the auto-retracting securable leash with pet id tag and thus a leash (109) within the stylized design case (110) and the stylized design case (110) to a pet's collar.

When the leash coupler base (205) is pulled from the at least one interior detent (160), the leash (109) may be pulled from the stylized design case (110), leaving the leash and collar connector (200) attached to a pet collar.

FIG. 6 shows a front view of an auto-retracting securable leash with pet id tag in an elliptical (oval) configuration.

Shown in FIG. 6 are the stylized design case (110), here in an elliptical (oval) configuration, a front case cover (115), and in for embodiments so equipped, a flat surface (170) of the front case cover (115). The flat surface (170) provides a suitable surface for attachment of a pet identification tag.

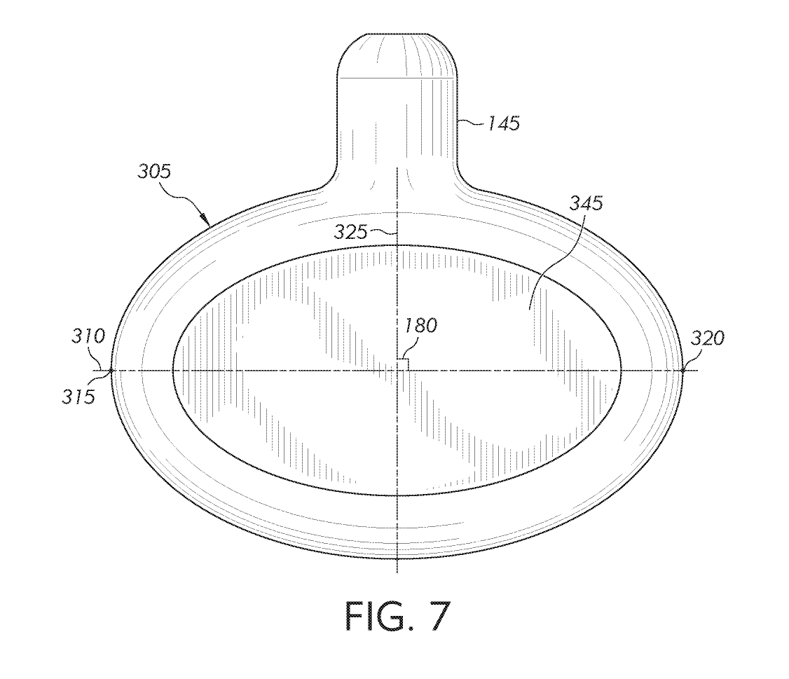

FIG. 7 shows a front view of an auto-retracting securable leash with pet id tag in an elliptical (oval) configuration with bisecting lines to show structural relationships.

Shown in FIG. 7 are an elliptical case (i.e., oval configuration) (305), the front case cover (115), the columnar housing 145, a horizontal bisecting line (310) of the front case cover (115), a proximal terminus (315) of the horizontal bisecting line (310), a distal terminus (320) of the horizontal bisecting line (310), a vertical bisecting line (325) of the front case cover (115). As indicated by the right angle symbol (180), the horizontal bisecting line (310) and the vertical bisecting line (325) are at right angles to each other.

As shown by FIG. 7, the horizontal bisecting line (310) from the proximal terminus (315) of the horizontal bisecting line (310) to the distal terminus (320) bisects the stylized design case (110) so that the upper and lower halves of the stylized design case (110) are a mirror image of each other, irrespective of the columnar housing, as well as the left and right sides of the stylized design case (110), with the columnar housing (145) centrally aligned to the vertical bisecting line (325) of the front case cover (115). In these embodiments, the auto-retracting securable leash with pet id tag may be quickly grasped regardless of front or back orientation, or of left or right orientation. The auto-retracting securable leash with pet id tag may thus remain attached to a pet collar while worn by the pet.

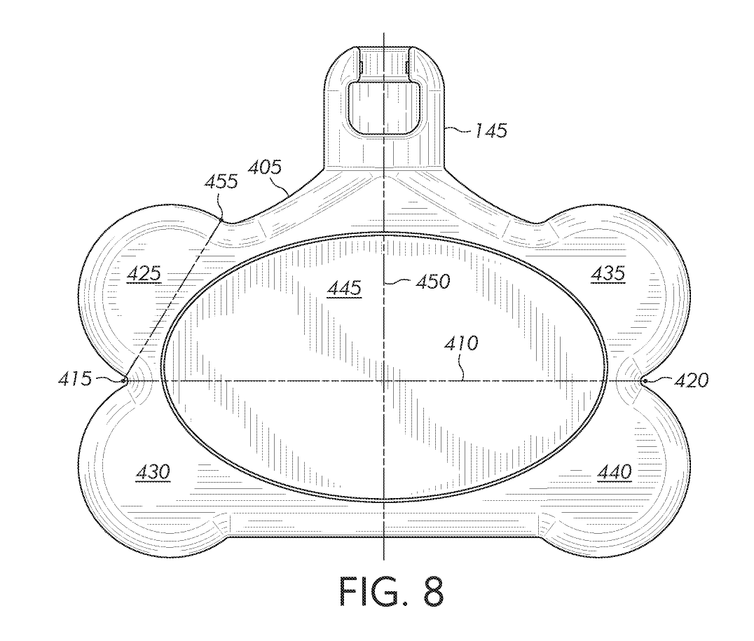

FIG. 8 shows a back view of an auto-retracting securable leash with pet id tag in a bone configuration with bisecting lines to show structural relationships.

Shown in FIG. 8 are a bone case (405), the columnar housing (145), a horizontal bisecting line (410) of the front case cover (445), a proximal terminus (415) of the horizontal bisecting line (410), a distal terminus (420) of the horizontal bisecting line (410), a first half-circle projection (425), a second half-circle projection (430), a third half-circle projection (435), a fourth half-circle projection (440), the front case cover (445), and an example of a half-circle diametric terminus (455).

As shown by FIG. 8, the horizontal bisecting line (410) from the proximal terminus (415) of the horizontal bisecting line (410) to the distal terminus (420) bisects the bone case (405) so that the upper and lower halves of the stylized design case (110) are a mirror image of each other, irrespective of the columnar housing (145), as well as the left and right sides of the bone case (405), with the columnar housing (145) centrally aligned to the vertical bisecting line (350) of the front case cover (445). In these embodiments, the auto-retracting securable leash with pet id tag may be quickly grasped regardless of front or back orientation, or of left or right orientation. The auto-retracting securable leash with pet id tag may thus remain attached to a pet collar while worn by the pet.

Towards assuring ease of use along with aesthetic appeal, in some embodiments, the bone case (405) incorporates geometric symmetry. In the embodiment presented in FIG. 8, there are four half-circle shapes, one in the upper left, one in the upper right, one in lower left and one in lower right.

As shown in the example of the upper left half-circle shape, a half-circle diametric terminus (455) strikes an acute angle of plus 60 degrees (more or less) to the horizontal bisecting line (410). As the half-circle diametric terminus (455) lies on the top surface of the bone case (405), this configuration presents an advantage in that the width of the bone case (405) provides a comfortable palm width, while the height of the bone case (405) provides a comfortable palm height. For symmetry, the other half-circle diametric termini strike a similar, but quadrant relative angle to the horizontal bisecting line (410), e.g., minus 60 degrees, plus 120 degrees, and minus 120 degrees.

To accommodate persons of other hand sizes, and other requirements, the positive acute angle may be in the range of plus 50 to 65 degrees, the negative acute angle may be in the range of plus 50 to 65 degrees, the negative obtuse angle may be in the range of minus 130 to 115 degrees and the positive obtuse angle may be in the range of plus 130 to 115 degrees.

This angular relationship thus provides for sizing the bone case (405) to widely different palm sizes. Thus, in some embodiments, the half-circle diametric terminus (455) strikes an angle of more than 60 degrees, e.g., plus (or minus) 75 degrees (with corresponding obtuse angles for the other termini) to the horizontal bisecting line (410) so that the proportional width of the bone case (405) to the height is less than in an embodiment having a 60 degree angle. Conversely, in an embodiment of which the half-circle diametric terminus (455) strikes an angle of less than 60 degrees, e.g., plus (or minus) 45 degrees (with corresponding obtuse angles for the other termini) to the horizontal bisecting line (410), the proportional width of the bone case (405) to the height is more than in an embodiment having a 60 degree angle.

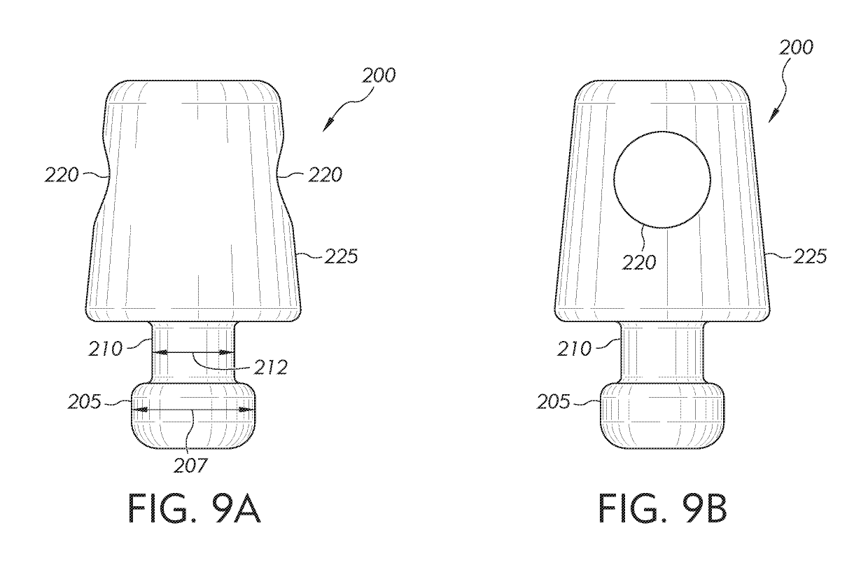

FIG. 9A shows a side view of flat-top embodiment of a leash and collar connector of an auto-retracting securable leash with pet id tag.

Shown in FIG. 9A are a leash and collar connector (200), a leash coupler base (205) of the leash and collar connector (200), a leash coupler base width (207), a leash coupler stem (210) of the leash and collar connector (200), a leash coupler stem width (212), as side view of a collar attachment device hole (220) and a leash coupler upper body (225).

As with the stylized design case (110), the leash and collar connector (200) may be made of any material capable to withstanding handling forces. In some embodiments, the handling force may be approximately 160 pounds. In some embodiments, the leash and collar connector (200) may be made of a plastic. In some embodiments, the plastic may be PVC.

As shown in FIG. 9A, the leash and collar connector (200) has a leash coupler base (205) and a leash coupler stem (210). As described earlier, the leash coupler base (205) fits into the leash coupler base port (150) of the columnar housing (145), while the leash coupler stem (210) fits into the leash coupler stem slot (155) of the columnar housing (145).

By matching the leash coupler base width (207) to the internal width of the leash coupler base port (150), the leash coupler base (205) fits snuggly within the leash coupler base port (150). In some embodiments, the leash coupler base width (207) is one-quarter inch (¼″).

By matching the leash coupler stem width (212) to slightly smaller than the internal width of the leash coupler stem slot (155), and matching the leash coupler stem width (212) to the at least one interior detent (160), the leash coupler stem (210) fits snuggly within the leash coupler stem slot (155). In some embodiments, the leash coupler stem width (212) is three-sixteenths inch ( 3/16″).

In addition, with the leash coupler stem width (212) having a smaller diameter than the leash coupler base width (207), columnar housing (145) verticals restrains the leash coupler upper body (225) of the leash and collar connector (200) as well.

In some embodiments, the overall combined height of the leash coupler base (205) plus the leash coupler stem slot (155) is three-eighths inch (⅜″).

Thus, with three restraining mechanisms of two different widths plus height, grasp of the leash and collar connector (200) by the columnar housing (145) is improved over other restraint systems. The auto-retracting securable leash with pet id tag may thus remain attached to a pet collar while worn by the pet without concern of the case coming loose and becoming entangled with an external object.

Above the leash coupler base (205) and a leash coupler stem (210) is a leash coupler upper body (225). Extending through the leash coupler upper body (225) is the leash hole (215). In this embodiment, the leash and collar connector (200) may use a collar attachment such as a split ring for attachment to a pet collar. In some embodiments, the leash coupler upper body (225) may have a conical mid-section (225B). In some embodiments, the leash coupler upper body (225) may have a flat upper base (225A). In some embodiments, the leash coupler upper body (225) may have a flat lower base (225C).

FIG. 9B shows a front view of flat-top embodiment of a leash and collar connector of an auto-retracting securable leash with pet id tag.

Shown in FIG. 9B are a leash and collar connector (200), a leash coupler base (205) of the leash and collar connector (200), a leash coupler stem (210) of the leash and collar connector (200), a leash hole (215) of the leash coupler base (205), a collar attachment device hole (220) of the leash coupler upper body (225), and the leash coupler upper body (225). As shown in FIG. 9B, the collar attachment device hole (220) passes entirely through the leash coupler upper body (225), allowing for a collar attachment device, to be affixed the leash coupler upper body (225), and thence to a collar.

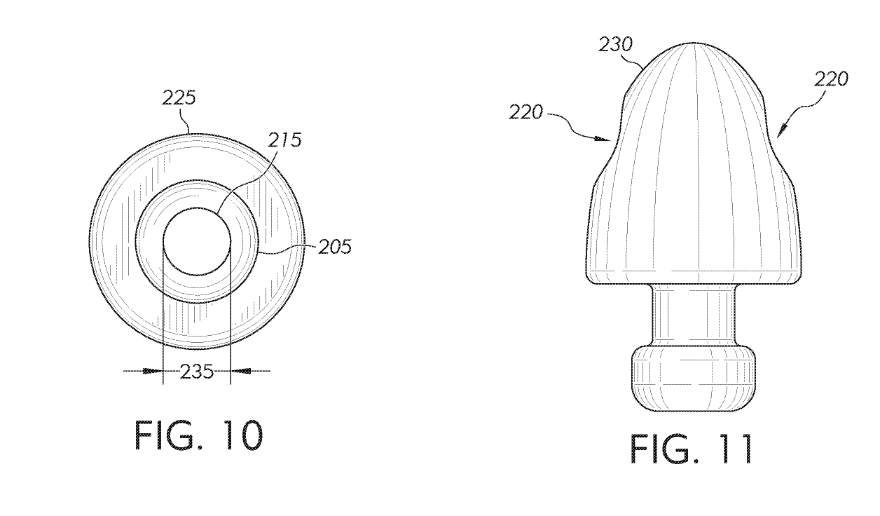

FIG. 10 shows a bottom view of a leash coupler base (205) for a leash and collar connector (200) of an auto-retracting securable leash with pet id tag.

Shown in FIG. 10 are the leash coupler base (205), a leash hole (215), and an outer portion of the leash coupler upper body flat lower base (225C) behind the leash coupler base (205). As shown in FIG. 9, the leash coupler stem (210) has a smaller width than the leash coupler base (205) and is thus not visible in this view.

As shown in FIG. 10, within the leash coupler base (205) has a leash hole (215) through which a leash (109) is threaded and captured within the leash coupler upper body (225). The leash hole diameter (235) is less than the leash coupler stem width (212).

In some embodiments, the leash (109) is encapsulated within the leash coupler upper body (225).

In some embodiments, the leash (109) is restrained within the leash coupler upper body (225). In some embodiments, the leash (109) is knotted. In some embodiments, the leash (109) uses an encapsulated clamp.

FIG. 11 shows a side view of round-top embodiment for a leash and collar connector of an auto-retracting securable leash with pet id tag.

As with the flattop embodiment, the round-top leash and collar connector (200) has a leash coupler base (205), a leash coupler stem (210) and a leash coupler upper body (225). The round-top embodiment differs from the flattop embodiment only in that the round-top embodiment has a rounded upper end, i.e., parabolic upper surface.

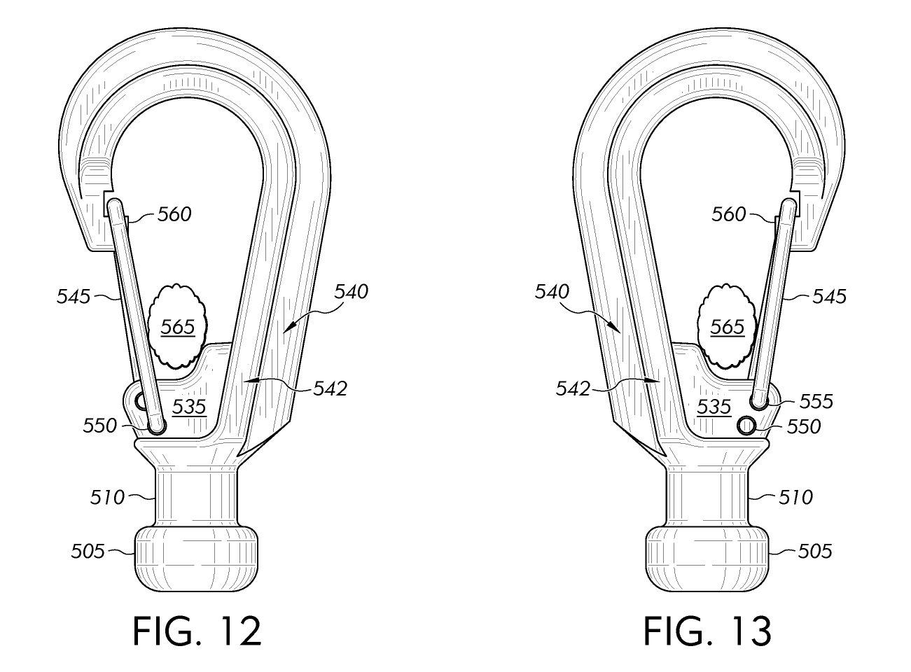

FIG. 12 shows a left side view of a carabiner leash and collar connector of an auto-retracting securable leash with pet id tag.

In this embodiment, the carabiner leash and collar connector (500) has a carabiner upper body instead of a conical upper body with a split ring hole.

Shown in FIG. 12 are a carabiner leash and collar connector (500), a leash coupler base (505), a leash coupler stem (510), a carabiner mid-section (535), a carabiner outer hook body (540), a carabiner inner hook body (542), a carabiner clip lower hole (550), a carabiner clip upper hole (555), a carabiner clip (545), a distal end carabiner clip notch (560) for holding the carabiner clip (545), and a leash knot (565).

As with the other embodiments of the leash and collar connector, the carabiner leash and collar connector (500) has a leash coupler base (505) and a leash coupler stem (510) configured to fit within leash coupler base port (150) and leash coupler stem slot (155) respectively.

The carabiner leash and collar connector (500) also has a configuration different from a typical carabiner. In this embodiment of the carabiner leash and collar connector (500), there are a carabiner mid-section (535) above the leash coupler base (505) and the leash coupler stem (510). Integrated to one side of the carabiner mid-section (535) are a carabiner outer hook body (540) and a carabiner inner hook body (542). The carabiner inner hook body (542) comprises a proximal end securely attached to the leash coupler stem (510) with an inner side adjacent to the proximal end securely attached to the carabiner mid-section (535). This configuration provides reinforced strength of the carabiner leash and collar connector (500) in spite of its light weight.

Within the carabiner mid-section (535) are a carabiner clip lower hole (550). Horizontally and vertically offside to the carabiner clip lower hole (550) is a carabiner clip upper hole (555). As shown in FIG. 12, one end of the carabiner clip (545) is in the carabiner clip lower hole (550), while the other end (partially visible) resides in the carabiner clip upper hole (555).

With the carabiner clip (545) placed in this horizontally and vertically offside configuration, the carabiner clip (545) is placed in tension, such that carabiner clip (545) acts to spring towards the distal end carabiner clip notch (560) and thus keep the carabiner leash and collar connector (500) affixed to a pet collar.

At their distal ends, the carabiner outer hook body (540) and the carabiner inner hook body (542) together form the distal end carabiner clip notch (560).

Located above the carabiner mid-section (535) is a leash knot (565), the leash having been threaded up through the leash coupler base (505), up through the leash coupler stem (510) and finally up through the carabiner mid-section (535). Thus placed into the carabiner and knotted, the leash is securely affixed to the carabiner leash and collar connector (500).

The auto-retracting securable leash with pet id tag may thus be securely attached to a pet collar with a carabiner and yet easily used as a leash.

FIG. 13 shows a right side view of a carabiner leash and collar connector of an auto-retracting securable leash with pet id tag. The left side view of the carabiner leash and collar connector (500) of an auto-retracting securable leash with pet id tag is the mirror image of the right side view with the significant difference of the orientation with regard to the carabiner clip lower hole (550) and the carabiner clip upper hole (555).

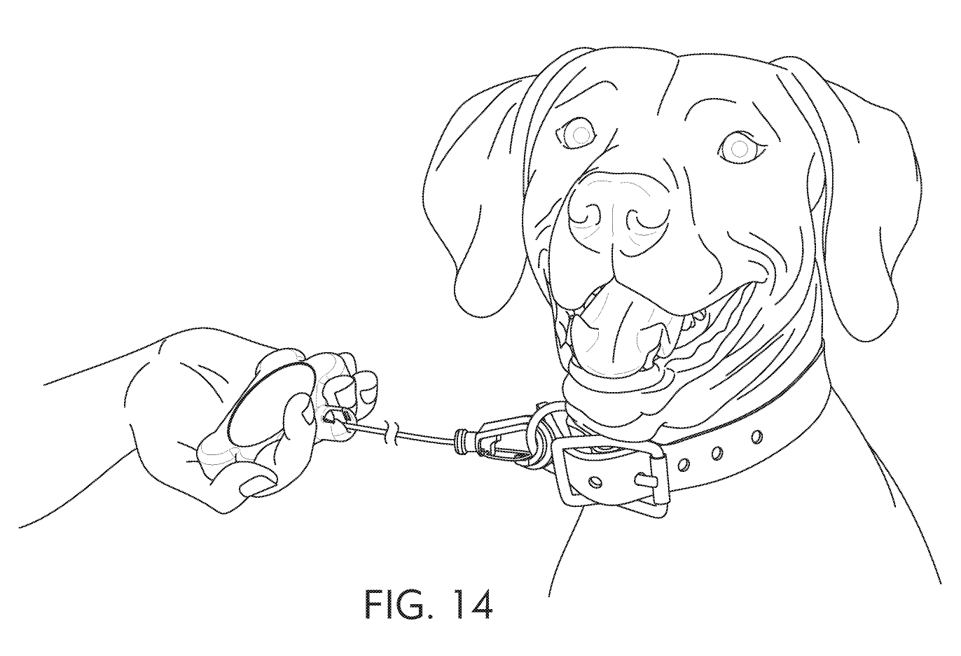

FIG. 14 shows a stylized design case (110) of an auto-retracting securable leash with pet id tag in a person's hand, with the stylized design case (110) tethered by the leash (109) to the leash and collar connector (200), which is attached to a pet collar of a pet.

These descriptions and drawings are embodiments and teachings of the disclosure. All variations are within the spirit and scope of the disclosure. This disclosure is not to be considered as limiting the claims to only the embodiments illustrated or discussed. Certain changes can be made in the subject matter without departing from the spirit and the scope of this invention. It is realized that changes are possible within the scope of this invention and it is further intended that each structure or element recited in any of the claims is to be understood as referring to all equivalent structure or elements. The following claims are intended to cover the invention as broadly as possible in whatever form it may be used.

What is claimed is:

1. An auto-retracting securable leash with pet id tag (100) comprising:
a leash spool (105) capable of bi-directional rotation wherein the leash spool (105) comprises an leash retracting mechanism (107) capable of auto-rotation in one direction wherein
the leash spool (105) is rotatably affixed within a stylized design case (110) wherein
the stylized design case (110) comprises a front case cover (115), a left case cover (120), a right case cover (125), a top case cover (130), a back case cover (135) and a bottom case cover (140), wherein
the top case cover (130) comprises a columnar housing (145), wherein
the columnar housing (145) comprises a leash coupler base port (150) capable of receiving within a leash coupler base (205), and a leash coupler stem slot (155) above the leash coupler base port (150) and capable of receiving within a leash coupler stem (210), and wherein
the columnar housing (145) further comprises at least one interior detent (160) capable of securing the leash coupler stem (210) within the columnar housing (145), and
the columnar housing (145) is capable of restraining a leash and collar connector (200) to the columnar housing (145) to restrain the stylized design case (110) to a pet collar.

2. The auto-retracting securable leash with pet id tag (100) of claim 1 wherein the front case cover (115) comprises a flat surface (170) sized to fit a pet identification tag (185).

3. The auto-retracting securable leash with pet id tag (100) of claim 1 wherein the leash retracting mechanism (107) comprises a coil spring and a spool spindle (108).

4. The auto-retracting securable leash with pet id tag (100) of claim 1 wherein the stylized design case (110) comprises
a front case cover (115) having a flat elliptical shape,
a back case cover (135) having a flat elliptical shape, wherein
a horizontal bisecting line (310) bisecting the front case cover (115) comprises a proximal terminus (315) and a distal terminus (320) at opposite terminus edges of the front case cover (115), with
a vertical bisecting line (325) bisecting the front case cover (115) wherein
the vertical bisecting line (325) perpendicularly bisects the horizontal bisecting line (310) such that the vertical bisecting line (325) is centrally located between the proximal terminus (315) and the distal terminus (320), wherein
the columnar housing (145) is centrally aligned on the vertical bisecting line (325) and is co-linear to the vertical bisecting line (325), and
the front case cover (115) is a mirror image of the back case cover (135).

5. The auto-retracting securable leash with pet id tag (100) of claim 1 wherein the stylized design case (110) comprises
a front case cover (445) having a flat elliptical center, wherein
a horizontal bisecting line (410) bisecting the front case cover (445) comprises a proximal terminus (415) and a distal terminus (420) at opposite terminus edges of the front case cover (445), wherein
the proximal terminus (415) comprises a first terminus point for a diametric line to the top case cover for a first half-circle projection (425) extending outward at a positive acute angle to the horizontal bisecting line (410),
the proximal terminus (415) comprises a first terminus point for a diametric line to the bottom case cover for a second half-circle projection (430) extending outward at a negative acute angle to the horizontal bisecting line (410),
the distal terminus (420) comprises a first terminus point for a diametric line to the top case cover for a third half-circle projection (435) extending outward at a positive obtuse angle to the horizontal bisecting line (410),
the distal terminus (420) comprises a first terminus point for a diametric line to the bottom case cover for a fourth half-circle projection (440) extending outward at a negative obtuse angle to the horizontal bisecting line (410), wherein
the front case cover (445) comprises a stylized bone design, wherein
a vertical bisecting line (450) bisecting the front case cover (445) wherein
the vertical bisecting line (450) perpendicularly bisects the horizontal bisecting line (410) such that the vertical bisecting line (450) is centrally located between the proximal terminus (415) and the distal terminus (420), wherein
the columnar housing (145) is centrally aligned on the vertical bisecting line (450) and is co-linear to the vertical bisecting line (450), and
the back case cover (135) is a mirror image of the front case cover (445).

6. The auto-retracting securable leash with pet id tag (100) of claim 1 further comprising
a leash and collar connector (200) comprising a leash coupler base (205) wherein the leash coupler base (205) comprises a leash coupler base width (207), wherein
the leash coupler base (205) is co-linear to and securely attached to a leash coupler stem (210) wherein the leash coupler stem (210) has a leash coupler stem width (212) wherein the leash coupler stem width (212) is less than the leash coupler base width (207), wherein
the leash coupler base (205) further comprises a leash hole (215) comprising a leash hole diameter (235) wherein the leash hole diameter (235) is less than the leash coupler stem width (212).

7. The leash and collar connector (200) of claim 6 further comprising a leash coupler upper body flat upper base (225A), a conical mid-section (225B), and a leash coupler upper body flat lower base (225C) securely attached to the leash coupler stem (210).

8. The leash and collar connector (200) of claim 6 further comprising a leash coupler upper body flat lower base (225C) securely attached to the leash coupler stem (210) and a parabolic upper surface (230).

9. The leash and collar connector (200) of claim 6 further comprising
a carabiner mid-section (535) securely attached to the leash coupler stem (510), wherein
the carabiner mid-section (535) comprising a carabiner clip lower hole (550) and a carabiner clip upper hole (555) wherein the carabiner clip lower hole (550) is discontinuous to the carabiner clip upper hole (555),
a carabiner inner hook body (542) comprising a proximal end securely attached to the leash coupler stem (510) and an inner side adjacent to the proximal end securely attached to the carabiner mid-section (535), wherein
a carabiner outer hook body (540) securely attached to the carabiner inner hook body (542) with a proximal end of the carabiner outer hook body (540) terminating at the leash coupler stem (510), and
a distal end of the carabiner inner hook body (542) and a distal end of the carabiner outer hook body (540) comprise a distal end carabiner clip notch (560) to receive a carabiner clip.

10. The auto-retracting securable leash with pet id tag (100) of claim 5 wherein the positive acute angle comprises an angle from plus 45 to 75 degrees, the negative acute angle comprises an angle from plus 45 to 75 degrees, the negative obtuse angle comprises an angle from minus 105 to 120 degrees and the positive obtuse angle comprises an angle from plus 105 to 120 degrees.

11. The leash and collar connector (200) of claim 8 further comprising a leash (109) within the leash and collar connector (200).

12. The leash and collar connector (200) of claim 11 wherein the leash comprises braided kevlar.

13. The leash and collar connector (200) of claim 11 further comprising a leash end within the leash and collar connector (200).

14. The leash end of claim 13 further comprising a knot of the leash end encapsulated within the leash and collar connector (200).

15. The leash end of claim 12 further comprising a clamp on the leash end encapsulated within the leash and collar connector (200).

16. A leash and collar connector (200) for an auto-retracting securable leash with pet id tag (100) comprising
a leash coupler base (205) comprising a leash coupler base width (207),
a leash coupler stem (210) co-linear to and securely attached to the leash coupler base (205) and comprising a leash coupler stem width (212) wherein the leash coupler stem width (212) is the less than the leash coupler base width (207),
a leash hole (215) passing through the leash coupler base (205) and the leash coupler stem (210) and comprising a leash hole diameter (235) wherein the leash hole diameter (235) is the less than the leash coupler stem width (212), and
a leash coupler upper body flat upper base (225A), a conical mid-section (225B), and a leash coupler upper body flat lower base (225C) co-linear to and securely attached to the leash coupler stem (210).
